(19) United States
(12) Patent Application Publication
(10) Pub. No.: US 2015/0311536 A1
(43) Pub. Date: Oct. 29, 2015

(54) NANOSTRUCTURED WHISKER ARTICLE

(71) Applicant: 3M INNOVATIVE PROPERTIES COMPANY, Saint Paul, MN (US)

(72) Inventors: Ljiljana L. Atanasoska, Oakland, CA (US); Radoslav Atanasoski, Oakland, CA (US); Gregory M. Haugen, Edina, MN (US); George D. Vernstrom, Cottage Grove, MN (US)

(73) Assignee: 3M INNOVATIVE PROPERTIES COMPANY, Saint Paul, MN (US)

(21) Appl. No.: 14/652,275

(22) PCT Filed: Dec. 16, 2013
(86) PCT No.: PCT/US2013/075402

§ 371 Date: Jun. 15, 2015

Related U.S. Application Data
(60) Provisional application No. 61/769,950, filed on Feb. 27, 2013.
(60) Provisional application No. 61/739,410, filed on Dec. 19, 2012.

(51) Int. Cl. H01M 4/88; H01M 4/90; H01M 4/92

(52) U.S. Cl. CPC H01M 4/8842; H01M 4/926; H01M 4/9008; H01M 2008/1095

(57) ABSTRACT

In one aspect, the present disclosure describes a first article comprising nanostructured whiskers having a first layer thereon comprising an organometallic compound comprising at least one of Ru or Ir. Optionally, the first layer further comprises an complex comprising at least one of Ru or Ir. Typically, the article includes at least one or more additional layers (e.g., a second layer comprising at least one of metallic Ir, Ir oxide, or Ir hydrated oxide on the first layer). Articles described herein are useful, for example, in fuel cell catalysts (i.e., an anode or cathode catalyst).

### CROSS REFERENCE TO RELATED APPLICATIONS

This application claims the benefit of U.S. Provisional Patent Application Nos. 61/739,410, filed Dec. 19, 2012 and 61/769,950, filed Feb. 27, 2013, the disclosures of which are incorporated by reference herein in their entireties.

### BACKGROUND

A proton exchange membrane (PEM) fuel cell transforms chemical energy liberated during the electrochemical reaction of hydrogen and oxygen to electrical energy. A stream of hydrogen is delivered to the anode side of the membrane electrode assembly (MEA). At the anode side the half-cell reaction is hydrogen oxidation reaction (HOR), which splits hydrogen into protons and electrons. The newly formed protons permeate through the polymer electrolyte membrane to the cathode side. The electrons travel along an external load circuit to the cathode side of the MEA, thus creating the current output of the fuel cell. Meanwhile, a stream of oxygen is delivered to the cathode side of the MEA. At the cathode side oxygen molecules react with the protons permeating through the polymer electrolyte membrane and the electrons arriving through the external circuit to form water molecules. This is reduction half-cell reaction or oxygen reduction reaction (ORR). Both half cell reactions are typically catalyzed by platinum based materials. Each cell produces about 1.1 volt, so to reach the required voltage the cells are combined to produce stacks. Each cell is divided with bipolar plates which while separating them provide a hydrogen fuel distribution channel, as well as a method of extracting the current. PEM fuel cells are considered to have the highest energy density of all the fuel cells, and due to the nature of the reaction have the quickest start up time (less than 1 second) so they have been favored for applications such as vehicles, portable power and backup power applications. Incorporation of oxygen evolution reaction (OER) catalysts to favor water electrolysis over carbon corrosion is a new material based strategy for achieving fuel cell durability during transient conditions by reducing cell voltage. Ru has excellent OER activity but it needs to be stabilized. Ir is well known for being able to stabilize Ru while Ir itself possesses a good OER activity. For a successful incorporation of OER catalysts, it is desired to prevent them from blocking and affecting Pt hydrogen oxidation reaction (HOR) or oxygen reduction reaction (ORR) activity.

### SUMMARY

In one aspect, the present disclosure describes an article comprising nanostructured whiskers having a first layer thereon comprising an organometallic compound comprising at least one of Ru or Ir. Optionally, the first layer further comprises an organometallic complex comprising at least one of Ru or Ir. Typically, the article includes at least one additional layers (e.g., a second layer comprising at least one of metallic Ir, Ir oxide, or Ir hydrated oxide on the first layer; a third layer comprising at least one of metallic Pt or Pt compound on the second layer; a fourth layer comprising at least one of metallic Pt or Pt compound on the third layer; a fifth layer comprising at least one of metallic Ir, Ir oxide, or Ir hydrated oxide on the fourth layer; a sixth layer comprising at least one of metallic Ru, Ru oxide, or Ru hydrated oxide on the firth layer; and a seventh layer comprising at least one of metallic Ir, Ir oxide, or Ir hydrated oxide on the sixth layer).

Articles described herein are useful, for example, in fuel cell catalysts (i.e., an anode or cathode catalyst).

### BRIEF DESCRIPTION OF THE DRAWING

The FIG. is an exemplary fuel cell including an article described herein.

### DETAILED DESCRIPTION

Nanostructured whiskers can be provided by techniques known in the art, including those described in U.S. Pat. No. 4,812,352 (Debe), U.S. Pat. No. 5,039,561 (Debe), U.S. Pat. No. 5,338,430 (Parsonage et al.), 6,136,412 (Spiewak et al.), and U.S. Pat. No. 7,419,741 (Verstrom et al.), the disclosures of which are incorporated herein by reference. In general, nanostructured whiskers can be provided, for example, by vacuum depositing (e.g., by sublimation) a layer of organic or inorganic onto substrate (e.g., a microstructured catalyst transfer polymer), and then converting the perylene red pigment into nanostructured whiskers by thermal annealing. Typically the vacuum deposition steps are carried out at total pressures at or below about 10⁻³ Torr or 0.1 Pascal. Exemplary microstructures are made by thermal sublimation and vacuum annealing of the organic pigment C.I. Pigment Red 149 (i.e., N,N′-di(3,5-xylyl)perylene-3,4:9,10-bis(dicarboximide)). Methods for making organic nanostructured layers are disclosed, for example, in Materials Science and Engineering, A158 (1992), pp. 1-6; J. Vac. Sci. Technol. A, 5 (4), July/August, 1987, pp. 1914-16; J. Vac. Sci. Technol. A, 6, (3), May/August, 1988, pp. 1907-11; Thin Solid Films, 186, 1990, pp. 327-47; J. Mat. Sci., 25, 1990, pp. 5257-68; Rapidly Quenched Metals, Proc. of the Fifth

Int. Conf. on Rapidly Quenched Metals, Wurzburg, Germany (Sep. 3-7, 1984), S. Steeb et al., eds., Elsevier Science Publishers B.V., New York, (1985), pp. 1117-24; Photo. Sci. and Eng., 24, (4), July/August, 1980, pp. 211-16; and U.S. Pat. Nos. 4,340,276 (Maffitt et al.) and 4,568,598 (Bilkadi et al.), the disclosures of which are incorporated herein by reference. Properties of catalyst layers using carbon nanotube arrays are disclosed in the article “High Dispersion and Electrocatalytic Properties of Platinum on Well-Aligned Carbon Nanotube Arrays,” Carbon 42 (2004) 191-197. Properties of catalyst layers using grassy or bristled silicon are disclosed in U.S. Pat. App. Pub. 2004/0048466 A1 (Gore et al.).

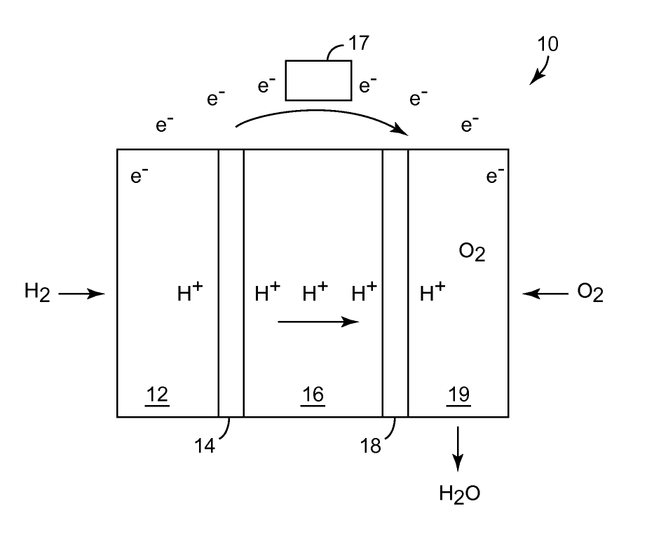

Vacuum deposition may be carried out in any suitable apparatus (see, e.g., U.S. Pat. No. 5,338,430 (Parsonage et al.), U.S. Pat. No. 5,879,827 (Debe et al.), U.S. Pat. No. 5,879,828 (Debe et al.), U.S. Pat. No. 6,040,077 (Debe et al.), and U.S. Pat. No. 6,319,293 (Debe et al.), and U.S. Pat. App. Pub. No. 2002/0004453 A1 (Haugen et al.), the disclosures of which are incorporated herein by reference. One exemplary apparatus is depicted schematically in FIG. 4A of U.S. Pat. No. 5,338,430 (Parsonage et al.), and discussed in the accompanying text, wherein the substrate is mounted on a drum which is then rotated over a sublimation or evaporation source for depositing the organic precursor (e.g., perylene red pigment) to the nanostructured whiskers.

Typically, the nominal thickness of deposited perylene red pigment is in a range from about 50 nm to 500 nm. Typically, the whiskers have an average cross-sectional dimension in a range from 20 nm to 60 nm and an average length in a range from 0.3 micrometer to 3 micrometers.

In some embodiments, the whiskers are attached to a backing. Exemplary backings comprise polyimide, nylon, metal foils, or other material that can withstand the thermal annealing temperature up to 300° C. In some embodiments, the backing has an average thickness in a range from 25 micrometers to 125 micrometers.

In some embodiments, the backing has a microstructure on at least one of its surfaces. In some embodiments, the microstructure is comprised of substantially uniformly shaped and sized features at least three (in some embodiments, at least four, five, ten or more) times the average size of the nanostructured whiskers. The shapes of the microstructures can, for example, be V-shaped grooves and peaks (see, e.g., U.S. Pat. No. 6,136,412 (Spiewak et al.), the disclosure of which is incorporated herein by reference) or pyramids (see, e.g., U.S. Pat. No. 7,901,829 (Debe et al.), the disclosure of which is incorporated herein by reference). In some embodiments some fraction of the microstructure features extend above the average or majority of the microstructured peaks in a periodic fashion, such as every 31^{st} V-groove peak is 25% or 50% or even 100% taller than those on either side of it. In some embodiments, this fraction of features that extend above the majority of the microstructured peaks can be up to 10% (in some embodiments up to 3%, 2%, or even up to 1%). Use of the occasional taller microstructure features may facilitate protecting the uniformly smaller microstructure peaks when the coated substrate moves over the surfaces of rollers in a roll-to-roll coating operation. The occasional taller feature touches the surface of the roller rather than the peaks of the smaller microstructures and so much less of the nanostructured material or whiskers is likely to be scraped or otherwise disturbed as the substrate moves through the coating process. In some embodiments, the microstructure features are substantially smaller than half the thickness of the membrane that the catalyst will be transferred to in making a membrane electrode assembly (MEA). This is so that during the catalyst transfer process, the taller microstructure features do not penetrate through the membrane where they may overlap the electrode on the opposite side of the membrane. In some embodiments, the tallest microstructure features are less than ⅓^{rd} or ¼^{th} of the membrane thickness. For the thinnest ion exchange membranes (e.g., about 10 micrometers to 15 micrometers in thickness), it may be desirable to have a substrate with microstructured features no larger than about 3 micrometers to 4.5 micrometers tall. The steepness of the sides of the V-shaped or other microstructured features or the included angles between adjacent features may in some embodiments be desirable to be on the order of 90° for ease in catalyst transfer during a lamination-transfer process and have a gain in surface area of the electrode that comes from the square root of two (1.414) surface area of the microstructured layer relative to the planar geometric surface of the substrate backing.

Exemplary organometallic complexes comprising at least one of Ru or Ir include complexes where Ru and Ir in valence states I-VIII form coordination bonds with organic ligands through hetero-atom(s) or non-carbon atom(s) such as oxygen, nitrogen, chalcogens (e.g., sulfur and selenium), phosphorus, or halide. . Exemplary Ru and Ir complexes with organic ligands can also be formed via π bonds. Organic ligands with oxygen hetero-atom include functional groups such as hydroxyl, ether, carbonyl, ester, carboxyl, aldehydes, anhydrides, cyclic anhydrides, and epoxy. Organic ligand with nitrogen hetero atom include functional groups such as amine, amide, imide, imine, azide, azine, pyrrole, pyridine, porphyrine, isocyanate, carbamate, carbamide sulfamate, sulfamide, amino acids, and N-heterocyclic carbine. Organic ligands with sulfur hetero atom, so-called thio-ligands include functional groups such as thiol, thioketone (thione or thiocarbonyl), thial, thiophene, disulfides, polysulfides, sulfimide, sulfoximide, and sulfonediimine Organic ligands with phosphorus hetero-atom include functional groups such as phosphine, phosphane, phosphanido, and phosphinidene. Exemplary organometallic complexes also include homo and hetero bimetallic complexes where both Ir and Ru are involved in coordination bonds with either homo or hetero functional organic ligands. Ru and Ir organometallic complexes formed via π coordination bonds include carbon rich π-conjugated organic ligands such as arenes, allyls, dienes, carbenes, and alkynyls. Examples or Ir and Ru organometallic complexes are also known as chelates, tweezer molecules, cages, molecular boxes, fluxional molecules, macrocycles, prism, half-sandwich, and metal-organic framework (MOF).

Exemplary organometallic compounds comprising at least one of Ru or Ir include compounds where Ru and Ir bond to organics via covalent, ionic or mixed covalent-ionic metal-carbon bonds. Exemplary organometallic compounds can also include combination of Ru and Ir covalent bonds to carbon atoms and coordination bond to organic ligands via hetero-atoms.

Metallic Ir refers to Ir metals, Ir alloys and Ir composites in an amorphous state, crystalline state or combination thereof.

Exemplary Ir compounds include Ir oxides, Ir hydrated oxides (i.e., hydrated Ir oxides), Ir polyoxometallate, Ir heteropolyacids, metal iridates, Ir nitrides, Ir oxonitrides, Ir carbides, Ir tellurides, Ir antimonides, Ir selenides, Ir borides, Ir sillicides, Ir arsenides, Ir phosphides, and Ir halides.

Exemplary Ir oxides include IrₓO_{y} forms where Ir valence could be, for example, 2-8. Specific exemplary Ir oxides include Ir₂O₃, and IrO₂, IrO₃, and IrO₄, as well as IrₓRu_{y}O_{z}, IrₓPt_{y}O_{z}, and IrₓRu_{y}Pt_{z}O_{zz}.

Metallic Pt refers to Pt metals, Pt alloys, and Pt composites in an amorphous state, crystalline state or combination thereof.

Exemplary Pt compounds include Pt oxides, Pt hydrated oxides, Pt hydroxides, Pt polyoxometallate, Pt heteropolyacids, metal platinates, Pt nitrides, Pt oxonitrides, Pt carbides, Pt tellurides, Pt antimonides, Pt selenides, Pt borides, Pt sillicides, Pt arsenides, Pt phosphides, Pt halides, Pt organometallic complexes, and chelates, as well as bi and multi metallic Pt compounds.

Exemplary Pt alloys include bi-, tri,-and multi-metallic Pt—Ir, Pt—Ru, Pt—Sn, Pt—Co, Pt—Pd, Pt—Au, Pt—Ag, Pt—Ni, Pt—Ti, Pt—Sb, Pt—In, Pt—Ga, Pt—W, Pt—Rh, Pt—Hf, Pt—Cu, Pt—Al, Pt—Fe, Pt—Cr, Pt—Mo, Pt—Mn, Pt—Zn, Pt—Mg, Pt—Os, Pt—Ge, Pt—As, Pt—Re, Pt—Ba, Pt—Rb, Pt—Sr, and Pt—Ce.

Metallic Ru means Ru metals, Ru alloys, and Ru composites in an amorphous state, crystalline state or combination thereof.

Exemplary Ru compounds include Ru oxides, Ru hydrated oxides (i.e., hydrated Ru oxides), Ru polyoxometallate, Ru heteropolyacids, metal ruthenates, Ru nitrides, Ru oxonitrides, Ru carbides, Ru tellurides, Ru antimonides, Ru selenides, Ru borides, Ru silicides, Ru arsenides, Ru phosphides, and Ru halides.

Exemplary Ru oxides include Ruₓ₁O_{y1}, where valence could be, for example, 2-8. Specific exemplary Ru oxides include Ru₂O₃, RuO₂, and RuO₃, as well as RuIrOx, RuPtOₓ, and RuIrPtOₓ.

In general, the layers of articles described herein can be deposited by techniques known in the art. Exemplary deposition techniques include those independently selected from the group consisting of sputtering (including reactive sputtering), atomic layer deposition, molecular organic chemical vapor deposition, molecular beam epitaxy, ion soft landing, thermal physical vapor deposition, vacuum deposition by electrospray ionization, and pulse laser deposition. Additional general details can be found, for example, in U.S. Pat. No. 5,879,827 (Debe et al.), U.S. Pat. No. 6,040,077 (Debe et al.), and. U.S. Pat. No. 7,419,741 (Vernstrom et al.), the disclosures of which are incorporated herein by reference).

Materials comprising the multiple alternating layers can be sputtered, for example, from a multiple targets (e.g., Ir is sputtered from a first target, Pt is sputtered from a second target, Ru from a third (if present), etc.), or from a target(s) comprising more than oneelement.

In some embodiments, sputtering is conducted at least in part in an atmosphere comprising at least a mixture of argon and oxygen, and wherein the ratio of argon to oxygen flow rates into the sputtering chamber are at least 113 sccm/7sccm.

In some embodiments, catalyst is coated in-line, in a vacuum immediately following the nanostructured whisker growth step on the microstructured substrate. This may be a more cost effective process so that the nanostructured whisker coated substrate does not need to be re-inserted into the vacuum for catalyst coating at another time or place. If the catalyst alloy coating is done with a single target, it may be desirable that the coating layer be applied in a single step onto the nanostructured whisker so that the heat of condensation of the catalyst coating heats the Ir, Pt, Ru, etc. atoms as applicable and substrate surface sufficient to provide enough surface mobility that the atoms are well mixed and form thermodynamically stable alloy domains. Alternatively the substrate can also be provided hot or heated to facilitate this atomic mobility, such as by having the nanostructured whisker coated substrate exit the perylene red annealing oven immediately prior to the catalyst sputter deposition step.

The ruthenium and iridium organometallics can be deposited, for example, by soft or reactive landing of mass selected ions. Soft landing of mass-selected ions is used to transfer catalytically-active metal complexes complete with organic ligands from the gas phase onto an inert surface. This method can be used to prepare materials with defined active sites and thus achieve molecular design of surfaces in a highly controlled way under either ambient or traditional vacuum conditions. For additional details see, for example, G. E. Johnson, M. Lysonsky and J. Laskin, Anal. Chem 2010, 82, 5718-5727, and G. E. Johnson and J. Laskin, Chemistry: A European Journal 16, 14433-14438.

The ruthenium and iridium organometallics can be deposited, for example, by thermal physical vapor deposition. This method uses high temperature (e.g., via resistive heating, electron beam gun, or laser) to melt or sublimate the target (source material) into vapor state which is in turn passed through a vacuum space, then condensing of the vaporized form to substrate surfaces. Thermal physical vapor deposition equipment is known in the art, including that available, for example, as an organic molecular evaporator from CreaPhys GmbH, Dresden, Germany

In some embodiments, at least one of the layers is annealed (e.g., radiation annealed at least in part). In some embodiments, the radiation annealing is conducted at an incident energy fluence of at least 20 mJ/mm², for example, with a 10.6 micrometer wavelength CO₂ laser having an average beam power of 30.7 watts and average beam width of 1 mm, that is delivered in the form of 30 microsecond pulses at a repetition rate of 20 kHz while scanning over the surface at about 7.5 m/sec in five sequential passes, each displaced 0.25 mm from the previous pass.

In some embodiments, the radiation annealing is conducted at least in part in an atmosphere comprising an absolute oxygen partial pressure of at least 2 kPa (in some embodiments, at least 5 kPa, 10 kPa, 15 kPa, or even at least 20 kPa) oxygen. The radiation annealing (e.g. laser annealing) is useful for rapidly heating the catalyst coating on the whiskers to effectively heat the catalyst coating so that there is sufficient atomic mobility that the alternately deposited layers are further intermixed to form more extensive alloying of the materials and larger crystalline grain sizes. It may be desirable for the radiation annealing to be able to be applied at sufficiently rapid web speeds that the process can match the original manufacturing process speeds of the nanostructured catalyst. For example it may be useful if the radiation annealing is conducted in line with the deposition process of the catalyst coating. It may be further be desirable if the radiation annealing is conducted in-line, in the vacuum, immediately follow the catalyst deposition.

It will be understood by one skilled in the art that the crystalline and morphological structure of a catalyst described herein, including the presence, absence, or size of alloys, amorphous zones, crystalline zones of one or a variety of structural types, and the like, may be highly dependent upon process and manufacturing conditions, particularly when three or more elements are combined.

In some embodiments, the first layer is directly on the nanostructured whiskers. In some embodiments, the first layer is at least one of covalently or ionically bonded to the nanostructured whiskers. In some embodiments, the first layer is adsorbed onto the nanostructured whisker. The first layer can be formed, for example as a uniform conformal coating or as dispersed discrete nanoparticles. Dispersed discrete tailored nanoparticles can be formed, for example, by a cluster beam deposition method by regulating the pressure of helium carrier gas or by self-organization. For additional details see, for example, Wan et al., Solid State Communications, 121, 2002, 251-256 or Bruno Chaudret, Top Organomet Chem, 2005, 16, 233-259.

While not wanting to be bound by theory, it is believed that the mechanism of Ru stabilization by Ir is not well understood, although it hypothesized that the corrosion of ruthenium is inhibited after alloying with Ir reference which may explain the phenomena cited R. Kotz and S. Stucki, J. Electrochem. Soc. 1985, 132(1) 103-107. In some embodiments of articles described herein, the layers collectively comprise a sufficient amount of Ir to stabilize the Ru against anodic dissolution.

In some embodiments of articles described herein, the layers collectively have an Ir:Ru atomic ratio range from 10:1 to 0.5:1.

Typically, the first layer has a planar equivalent thickness in a range from 0.2 nm to 50 nm (in some embodiments, in a range from 0.1 nm to 0.3 nm); the second layer a thickness in a range from 0.2 nm to 50 nm (in some embodiments, in a range from 0.7 nm to 4 nm); the third layer a thickness in a range from 0.2 nm to 50 nm (in some embodiments, in a range from 5 nm to 10 nm); the fourth layer a thickness in a range from 0.2 nm to 50 nm (in some embodiments, in a range from 5 nm to 10 nm); the fifth layer a thickness in a range from 0.2 nm to 50 nm (in some embodiments, in a range from 0.7 nm to 4 nm); the sixth layer a thickness in a range from 0.2 nm to 50 nm (in some embodiments, in a range from 0.1 nm to 0.3 nm); and the seventh layer a thickness in a range from 0.2 nm to 50 nm (in some embodiments, in a range from 0.7 nm to 4 nm). Typically, the collective thickness of the seven layers is in a range from 1.5 nm to 350 nm (in some embodiments, in a range from 10 nm to 35 nm). “Planar equivalent thickness” refers to a layer distributed on a surface, which may be distributed unevenly, and which surface may be an uneven surface (such as a layer of snow distributed across a landscape, or a layer of atoms distributed in a process of vacuum deposition), a thickness calculated on the assumption that the total mass of the layer was spread evenly over a plane covering the same projected area as the surface (noting that the projected area covered by the surface is less than or equal to the total surface area of the surface, once uneven features and convolutions are ignored). In some embodiments, the layers may be discontinuous.

Articles described herein are useful, for example, in fuel cell catalysts (i.e., an anode or cathode catalyst). Referring to the FIG., fuel cell 10 includes first gas diffusion layer (GDL) 12 adjacent anode 14. Adjacent the anode 14 includes electrolyte membrane 16. Cathode 18 is adjacent electrolyte membrane 16, and second gas diffusion layer 19 is adjacent the cathode 18. GDLs 12 and 19 can be referred to as diffuse current collectors (DCCs) or fluid transport layers (FTLs). In operation, hydrogen fuel is introduced into the anode portion of fuel cell 10, passing through first gas diffusion layer 12 and over anode 14. At anode 14, the hydrogen fuel is separated into hydrogen ions (H⁺) and electrons (e⁻).

Electrolyte membrane 16 permits only the hydrogen ions or protons to pass through electrolyte membrane 16 to the cathode portion of fuel cell 10. The electrons cannot pass through electrolyte membrane 16 and, instead, flow through an external electrical circuit in the form of electric current. This current can power, for example, electric load 17, such as an electric motor, or be directed to an energy storage device, such as a rechargeable battery.

Oxygen flows into the cathode side of fuel cell 10 via second gas diffusion layer 19. As the oxygen passes over cathode 18, oxygen, protons, and electrons combine to produce water and heat. In some embodiments, the fuel cell catalyst comprises no electrically conductive carbon-based material (i.e., perylene red, fluoropolymers, or polyolefines).

### EXEMPLARY EMBODIMENTS

1. An article comprising nanostructured whiskers having a first layer thereon comprising an organometallic compound comprising at least one of Ru or Ir.
2. The article of Embodiment 1, wherein the first layer further comprising an organometallic complex comprising at least one of Ru or Ir.
3. The article of either Embodiment 1 or 2, wherein the first layer is directly on the nanostructured whiskers.
4. The article of any preceding Embodiment, wherein the organometallic compound is at least one of oxide or hydrated oxide.
5. The article of any preceding Embodiment, wherein the first layer is at least one of covalently or inonically bonded to the nanostructured whiskers.
6. The article of any of Embodiment 1 to 4, wherein the first layer is adsorbed onto the nanostructured whiskers.
7. The article of any preceding Embodiment, wherein the first layer has a thickness in a range from 0.2 nm to 50 nm (in some embodiments, in a range from 0.1 nm to 0.3 nm).
8. The article of any preceding Embodiment, further comprising a second layer comprising at least one of metallic Ir, Ir oxide, or Ir hydrated oxide on the first layer.
9. The article of Embodiment 8, wherein the second layer has a thickness in a range from 0.2 nm to 50 nm (in some embodiments, in a range from 0.7 nm to 4 nm).
10. The article of either Embodiment 8 or 9, further comprising a third layer comprising at least one of metallic Pt or Pt compound on the second layer.
11. The article of Embodiment 10, wherein the third layer has a thickness in a range from 0.2 nm to 50 nm (in some embodiments, in a range from 5 nm to 10 nm).
12. The article of either Embodiment 10 or 11, further comprising a fourth layer comprising at least one of metallic Pt or Pt compound on the third layer.
13. The article of Embodiment 11, wherein the fourth layer has a thickness in a range from 0.2 nm to 50 nm (in some embodiments, in a range from 5 nm to 10 nm).
14. The article of either Embodiment 12 or 13, further comprising a fifth layer comprising at least one of metallic Ir, Ir oxide, or Ir hydrated oxide on the fourth layer.
15. The article of Embodiment 14, wherein the fifth layer has a thickness in a range from 0.2 nm to 50 nm (in some embodiments, in a range from 0.7 nm to 4 nm).
16. The article of either Embodiment 14 or 15, further comprising a sixth layer comprising at least one of metallic Ru, Ru oxide, or Ru hydrated oxide on the firth layer.
17. The article of Embodiment 16, wherein the sixth layer has a thickness in a range from 0.2 nm to 50 nm (in some embodiments, in a range from 0.1 nm to 0.3 nm).
18. The article of either Embodiment 16 or 17, further comprising a seventh layer comprising at least one of metallic Ir, Ir oxide, or Ir hydrated oxide on the sixth layer.
19. The article of Embodiment 18, wherein the seventh layer has a thickness in a range from 0.2 nm to 50 nm (in some embodiments, in a range from 0.7 nm to 4 nm).
20. The article of either Embodiment 18 or 19, wherein the collective thickness of the seven layers is in a range from 1.5 nm to 350 nm (in some embodiments, in a range from 10 nm to 35 nm).
21. The article of any of Embodiments 18 to 20, wherein the layers collectively comprise a sufficient amount of Ir to stabilize the Ru against anodic dissolution.
22. The article of any of Embodiments 18 to 21, wherein the layers collectively have an Ir:Ru atomic ratio range from 10:1 to 0.5:1.
23. The article of any preceding Embodiment, wherein the nanostructured whiskers are attached to a backing (e.g., a membrane).
24. The article of Embodiment 23, wherein the backing has a microstructure on at least one of its surfaces.
25. A fuel cell catalyst comprising the article of any preceding Embodiment.
26. The fuel cell catalyst according to Embodiment 25 which comprises no electrically conductive carbon-based material.
27. A fuel cell membrane electrode assembly comprising an anode or cathode catalyst which is a fuel cell catalyst according to either Embodiment 25 or 26.
28. A method of making the article of any of Embodiments 1 to 24, the method comprising depositing any of the layers via a deposition technique independently selected from the group consisting of sputtering (including reactive sputtering), atomic layer deposition, molecular organic chemical vapor deposition, molecular beam epitaxy, ion soft landing, thermal physical vapor deposition, vacuum deposition by electrospray ionization, and pulse laser deposition.
29. The method of Embodiment 28, further comprising annealing at last one of the layers.

Foreseeable modifications and alterations of this disclosure will be apparent to those skilled in the art without departing from the scope and spirit of this invention. This invention should not be restricted to the embodiments that are set forth in this application for illustrative purposes.

1. An article comprising nanostructured whiskers having a first layer thereon comprising an organometallic compound comprising at least one of Ru or Ir.

2. The article of claim 1, wherein the first layer further comprising an organometallic complex comprising at least one of Ru or Ir.

3. The article of either claim 1, wherein the first layer is directly on the nanostructured whiskers.

4. The article of claim 1, wherein the organometallic compound is at least one of oxide or hydrated oxide.

5. The article of claim 1, wherein the first layer is at least one of covalently or ionically bonded to the nanostructured whiskers.

6. The article of claim 1, wherein the first layer is adsorbed onto the nanostructured whiskers.

7. The article of claim 1, further comprising a second layer comprising at least one of metallic Ir, Ir oxide, or Ir hydrated oxide on the first layer.

8. The article of claim 7, further comprising a third layer comprising at least one of metallic Pt or Pt compound on the second layer.

9. The article of claim 8, further comprising a fourth layer comprising at least one of metallic Pt or Pt compound on the third layer.

10. The article of claim 9, further comprising a fifth layer comprising at least one of metallic Ir, Ir oxide, or Ir hydrated oxide on the fourth layer.

11. The article of either 10, further comprising a sixth layer comprising at least one of metallic Ru, Ru oxide, or Ru hydrated oxide on the firth layer.

12. The article of claim 11, further comprising a seventh layer comprising at least one of metallic Ir, Ir oxide, or Ir hydrated oxide on the sixth layer.

13. The article of claim 12, wherein the collective thickness of the seven layers is in a range from 1.5 nm to 350 nm.

14. The article of claim 12, wherein the layers collectively comprise a sufficient amount of Ir to stabilize the Ru against anodic dissolution.

15. The article of claim 12, wherein the layers collectively have an Ir:Ru atomic ratio range from 10:1 to 0.5:1.

16. A fuel cell catalyst comprising the article of claim 1.

17. The fuel cell catalyst according to claim 16 which comprises no electrically conductive carbon-based material.

18. A fuel cell membrane electrode assembly comprising an anode or cathode catalyst which is a fuel cell catalyst according to claim 16.

19. A method of making the article of claim 1 wherein any of the layers is deposited via a deposition technique independently selected from the group consisting of sputtering, atomic layer deposition, molecular organic chemical vapor deposition, molecular beam epitaxy, ion soft landing, thermal physical vapor deposition, vacuum deposition by electrospray ionization, and pulse laser deposition.

20. The method of claim 19, further comprising annealing at last one of the layers.
